(19) United States
(12) Patent Application Publication
(10) Pub. No.: US 2026/0280641 A1
(43) Pub. Date: Sep. 17, 2026

(54) WIRELESS COMMUNICATION METHODS AND APPARATUSES

(71) Applicant: LENOVO (BEIJING) LIMITED, Beijing (CN)

(72) Inventors: Hongmei LIU, Beijing (CN); Yuantao ZHANG, Beijing (CN); Zhi YAN, Beijing (CN); Ruixiang MA, Beijing (CN)

(21) Appl. No.: 19/469,065

(22) PCT Filed: Aug. 16, 2023
(86) PCT No.: PCT/CN2023/113252

§ 371 Date: Sep. 25, 2025

(51) Int. Cl. H04B 7/06; H04L 5/00; H04W 72/23

(52) U.S. Cl. CPC H04B 7/0626; H04L 5/0094; H04W 72/23

(57) ABSTRACT

Various aspects of the present disclosure relate to a wireless communication method and apparatus of supporting beam reporting. An exemplary UE includes: at least one memory; and at least one processor coupled with the at least one memory and configured to cause the UE to: receive a first signaling indicating a CSI-RS resource set; receive a second signaling indicating one or multiple port subset indications associated with the CSI-RS resource set or indicating a first number smaller than a number of CSI-RS resources in the CSI-RS resource set; and determine, based on the first signaling and the second signaling, an index of a CSI-RS resource for CRI reporting, an association between CMR and IMR, an index of a CSI reporting configuration, or any combination thereof.

### TECHNICAL FIELD

The present disclosure relates to wireless communications, and more specifically to wireless communication methods and apparatuses.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the methods and apparatuses described herein may further include a UE for wireless communication, which includes: at least one memory; and at least one processor coupled with the at least one memory and configured to cause the UE to: receive a first signaling indicating a channel state information (CSI) reference signal (RS) (CSI-RS) resource set; receive a second signaling indicating one or multiple port subset indications associated with the CSI-RS resource set or indicating a first number smaller than a number of CSI-RS resources in the CSI-RS resource set; and determine, based on the first signaling and the second signaling, an index of a CSI-RS resource for CSI-RS resource indicator (CRI) reporting, an association between channel measurement resource (CMR) and interference measurement resource (IMR), an index of a CSI reporting configuration, or any combination thereof.

In some implementations of the methods and apparatuses described herein, the at least one processor is configured to cause the UE to: determine a set of port subset indications for the CSI-RS resource set based on port subset indications for each CSI-RS resource in the CSI-RS resource set.

In some implementations of the methods and apparatuses described herein, each port subset indication of the set of port subset indications is identified by an index.

In some implementations of the methods and apparatuses described herein, port subset indications for each CSI-RS resource of the CSI-RS resource set are same or different.

In some implementations of the methods and apparatuses described herein, in the case that the port subset indications for each CSI-RS resource are the same, a set of port subset indications for the CSI-RS resource set is the one or multiple port subset indications.

In some implementations of the methods and apparatuses described herein, in the case that the port subset indications for each CSI-RS resource are different, a set of port subset indications for the CSI-RS resource set contains port subset indications for all CSI-RS resources of the CSI-RS resource set.

In some implementations of the methods and apparatuses described herein, the at least one processor is configured to cause the UE to: determine a CSI-RS resource subset of the CSI-RS resource set for each port subset indication based on port subset indications for each CSI-RS resource of the CSI-RS resource set; and determine an index of a CSI-RS resource associated with a port subset indication based on a CSI-RS resource subset associated with the port subset indication to be reported.

In some implementations of the methods and apparatuses described herein, the at least one processor is configured to cause the UE to: determine one or multiple CSI-RS resource subsets by dividing the CSI-RS resource set by the first number, wherein, a number of CSI-RS resources in each of the one or multiple CSI-RS resource subsets equals to the first number, or a number of the one or multiple CSI-RS resource subsets equals to the first number.

In some implementations of the methods and apparatuses described herein, CSI-RS resources in a CSI-RS resource subset are associated with a same CSI reporting configuration or different CSI reporting configurations.

In some implementations of the methods and apparatuses described herein, in the case that the CSI-RS resources in a CSI-RS resource subset are associated with the same CSI reporting configuration, the at least one processor is configured to cause the UE to determine an index of a CSI-RS resource in the CSI-RS resource subset to be reported.

In some implementations of the methods and apparatuses described herein, in the case that the CSI-RS resources in a CSI-RS resource subset are associated with different CSI reporting configurations, the at least one processor is configured to cause the UE to determine multiple CSI-RS resource groups of the CSI-RS resource set based on an association between CSI-RS resource and CSI reporting configuration, wherein, CSI-RS resources in each of the multiple CSI-RS resource groups are associated with a same CSI reporting configuration.

In some implementations of the methods and apparatuses described herein, the at least one processor is configured to cause the UE to determine an index of a CSI-RS resource of a CSI-RS resource group of the multiple CSI-RS resource groups to be reported.

In some implementations of the methods and apparatuses described herein, the at least one processor is configured to cause the UE to receive a third signaling indicating an IMR set, and the CSI-RS resource set indicated by the first signaling is for channel measurement.

In some implementations of the methods and apparatuses described herein, a number of IMRs in the IMR set is same as the number of CSI-RS resources in the CSI-RS resource set, and the one or multiple port subset indications are associated with a same IMR.

In some implementations of the methods and apparatuses described herein, the at least one processor is configured to cause the UE to determine an IMR associated with a port subset indication based on a CSI-RS resource associated with the IMR.

In some implementations of the methods and apparatuses described herein, a number of IMRs in the IMR set is determined based on the number of CSI-RS resources in CSI-RS resource set and a largest number of port subset indications among those of port subset indications for each CSI-RS resource in the CSI-RS resource set.

In some implementations of the methods and apparatuses described herein, numbers of port subset indications for different CSI-RS resources in the CSI-RS resource set are same or different.

In some implementations of the methods and apparatuses described herein, the at least one processor is configured to cause the UE to determine an index of the IMR associated with a port subset indication based on an index of the associated CSI-RS resource and an index of the associated port subset indication.

In some implementations of the methods and apparatuses described herein, a number of IMRs in the IMR set equals to the number of CSI-RS resources in CSI-RS resource set, a number of CSI-RS resource subsets determined by dividing the CSI-RS resource set by the first number, or a number of CSI-RS resources in a CSI-RS resources subset.

In some implementations of the methods and apparatuses described herein, CSI-RS resources of a CSI-RS resource subset are associated with a same IMR.

In some implementations of the methods and apparatuses described herein, the at least one processor is configured to cause the UE to: determine an index for each CSI-RS resources of a CSI-RS resource subset to identify the CSI-RS resource within the CSI-RS resource subset based on an order of the CSI-RS resource within the CSI-RS resource subset; and determine the IMR associated with each CSI-RS resource of the CSI-RS resource subset based on the index.

In some implementations of the methods and apparatuses described herein, the at least one processor is configured to cause the UE to: receive a third signaling indicating a number of CSI reporting configurations; and transmit indexes of one or more CSI reporting configurations based on the number of CSI reporting configurations, wherein, each CSI reporting configuration index is based on a subset index.

In some implementations of the methods and apparatuses described herein, the at least one processor is configured to cause the UE to: receive a third signaling indicating a number of CSI reporting configurations; and transmit indexes of one or more CSI reporting configurations based on the number of CSI reporting configurations, wherein, each CSI reporting configuration index is based on a group index.

Some implementations of the methods and apparatuses described herein may further include a processor for wireless communication, which includes: at least one controller coupled with at least one memory and configured to cause the at least one processor to: receive a first signaling indicating a CSI-RS resource set; receive a second signaling indicating one or multiple port subset indications associated with the CSI-RS resource set or indicating a first number smaller than a number of CSI-RS resources in the CSI-RS resource set; and determine, based on the first signaling and the second signaling, an index of a CSI-RS resource for CRI reporting, an association between CMR and IMR, an index of a CSI reporting configuration, or any combination thereof.

Some implementations of the methods and apparatuses described herein may further include a network equipment (NE) for wireless communication, which includes: at least one memory; and at least one processor coupled with the at least one memory and configured to cause the RAN node to: transmit a first signaling indicating a CSI-RS resource set; transmit a second signaling indicating one or multiple port subset indications associated with the CSI-RS resource set or indicating a first number smaller than a number of CSI-RS resources in the CSI-RS resource set; and determine, an index of a CRI reporting, an association between CMR and IMR, an index of a CSI reporting configuration, or any combination thereof, based on the CSI-RS resource set and the one or multiple port subset indications or the first number.

Some implementations of the methods and apparatuses described herein may further include a method performed by a UE, which includes: receiving a first signaling indicating a CSI-RS resource set; receiving a second signaling indicating one or multiple port subset indications associated with the CSI-RS resource set or indicating a first number smaller than a number of CSI-RS resources in the CSI-RS resource set; and determining, based on the first signaling and the second signaling, an index of a CSI-RS resource for CRI reporting, an association between CMR and IMR, an index of a CSI reporting configuration, or any combination thereof.

### BRIEF DESCRIPTION OF THE DRAWINGS

FIG. 1 illustrates an example of a wireless communications system in accordance with aspects of the present disclosure.

FIG. 2 is an example of association between spatial domain adaption patterns and CSI-RS resources in Type 1 case in accordance with aspect of the present disclosure.

FIG. 3 is an example of association among spatial domain adaption pattern, IMR and IMR in Type 1 case in accordance with aspect of the present disclosure.

FIG. 4 is an example of association among spatial domain adaption pattern, IMR and CMR in Type 2 case in accordance with aspect of the present disclosure.

FIG. 5 is also an example of association among spatial domain adaption pattern, IMR and CMR in Type 2 case in accordance with aspect of the present disclosure.

FIG. 6 illustrates an example of a user equipment (UE) 600 in accordance with aspects of the present disclosure.

FIG. 7 illustrates an example of a processor 700 in accordance with aspects of the present disclosure.

FIG. 8 illustrates an example of a network equipment (NE) 800 in accordance with aspects of the present disclosure.

FIG. 9 illustrate a flowchart of method performed by a UE in accordance with aspects of the present disclosure.

FIG. 10 illustrate a flowchart of method performed by a NE in accordance with aspects of the present disclosure.

### DETAILED DESCRIPTION

Considering radio access network (RAN)1 meeting agreements on multiple CSI reporting configurations (or referred to as CSI reporting sub-configurations, or sub-configurations, or configurations, or the like) corresponding to different spatial domain adaptation patterns (or referred to as spatial adaption patterns) and support both beams (or referred to spatial domain info, quasi co-location (QCL)info, direction, angle, or the like) and spatial domain adaptation patterns in a CSI-RS resource set (or referred to as a CSI-RS set), there are a mass of issues or technical problems to be studied and solved in the industry. Exemplary technical problems to be solved concern: how to index beams and spatial domain adaptation patterns, how to determine interference measurement resources for each spatial domain adaptation pattern, and how to select or skip some CSI reporting configurations etc. Regarding a beam, it can be represented by various manners, such as RS, spatial domain filter, or QCL assumption etc.

In accordance with aspects of the present disclosure, all these technical problems are considered in view of Type 1 (type 1 or TYPE 1) and Type 2 (type 2 or TYPE 2) cases in RAN1 on normal examples for network energy saving (NES) spatial domain adaptations. Spatial domain adaptation (or referred to as spatial adaption) in view of Type 1 and Type 2 cases respectively are also referred to as Type 1 spatial domain adaption (or Type 1 adaption) and Type 2 spatial domain adaption (or Type 2 adaption). In Type 1 case, all antenna elements associated to a logical antenna port is disabled or enabled. As a result, there will be different antenna port numbers associated with different Type 1 spatial adaptation patterns. In Type 2, part or subset of antenna elements associated to a logical antenna port is disabled or enabled. Consequently, different Type 2 spatial adaptations are associated with the same antenna number, while the beam (or spatial beam) may change among different spatial adaptation patterns.

For example, in accordance with aspects of the present disclosure, in Type 1 case, each port subset indication is associated with a CSI reporting configuration, e.g., associated with a CSI reporting configuration index. There is always configuration of CSI-RS resource ports for a CSI-RS resource. In addition to that, a port subset indication can be configured for a CSI-RS resource. When there is a CSI-RS resource set, each CSI-RS resource in the resource set can be configured a port subset indication. Or alternatively, a port subset indication is applied to all the CSI-RS resources in the CSI-RS resource set. If there is a single CSI reporting configuration for a CSI-RS resource set, with multiple port subset indications, there will be multiple CSI reporting sub-configurations associated with the CSI reporting configuration. Eash sub-configuration can be associated with a port subset indication. Port subset indications for a CSI-RS resource set is a set (or a union set) of port subset indications for each CSI-RS resource (or referred to as a CSI-RS) of the CSI-RS resource set. For each port subset indication, a subset of CSI-RS resources is determined based on the same port subset indication. Each port subset indication is also associated with a spatial domain adaptation pattern. When CRI (CSI-RS resource index) reporting for each spatial domain adaptation is configured, determination of a CSI-RS resource index is based on the subset of CSI-RS resources associated with each port subset indication. If the subset of CSI-RS resource is different from the original CSI-RS resource set, indexing of CSI-RS resource within the subset can be considered for CRI reporting. Or alternatively, indexing within the original CSI-RS resource set can also be considered. Regarding IMR, various implementations of the present disclosure are disclosed when the CSI-RS resource set is used for channel measurement. In some implementations of the present disclosure, multiple port subset indications of the same CSI-RS resource are associated with the same IMR. The number of IMRs is the same as the number of CMRs, e.g., the number of CSI-RS resources of the CSI-RS resource set. In some other implementations of the present disclosure, each port subset indication of a CSI-RS resource is associated with an IMR. The number of IMRs is determined by multiplying the number of CMRs and the number of port subset indications. The number of port subset indications can be the number of port subset indications for a single CSI-RS resource. Alternatively, the number of port subset indications can be the largest number among those of port subset indications for each CSI-RS resource of the CSI-RS resource set.

In accordance with aspects of the present disclosure, in Type 2 case, a beam number or spatial adaptation number is configured to divide the CSI-RS resource set into multiple CSI-RS resource subsets. Each CSI-RS resource is associated with a beam index and a spatial adaptation pattern index. The CSI-RS resources associated with same spatial adaptation pattern index can be adopted to construct a CSI-RS resource subset. There can be one or multiple CSI-RS resource subsets, and each is associated with a spatial adaptation pattern. When there is CRI reporting for each spatial adaptation pattern, CSI-RS resource indexing can be based on the determined CSI-RS subset for each spatial adaptation pattern. The CSI-RS resource indexing can be based on its index within the subset, or alternatively, the CSI-RS resource indexing can also be based on its index in the original CSI-RS resource set.

The CSI-RS resources associated with the same beam index can also be adopted to construct a CSI-RS group. There can be one or multiple CSI-RS groups, and each CSI-RS group is associated with a beam index. Different CSI-RS resources within the CSI-RS group are associated with different spatial adaptation patterns. Different spatial adaptation pattern can be associated with different CSI reporting configurations or different CSI reporting sub-configurations. Similarly, regarding IMR, various implementations of the present disclosure are disclosed when the CSI-RS resource set is used for channel measurement. In some implementations of the present disclosure, the number of IMRs is the same as the number of CMRs, e.g., the number of CSI-RS resources of the CSI-RS resource set, the IMRs and CMRs are one to one mapped. In some other implementations of the present disclosure, the number of IMRs is the number of beams of CMRs, and all CSI-RS resource(s) sharing the same spatial adaptation pattern are mapped to the same IMR. In some yet other implementations of the present disclosure, the number of IMRs is the number of spatial adaptation patterns of CMRs, and all the CSI-RS resources sharing the same beam are mapped to the same IMR.

Implementations of the present disclosure at least solve issues related to indexing of beams and spatial adaptation patterns for both Type 1 and Type 2 spatial domain adaptation for CRI reporting, interference measurement resource determination, and UE selected reporting for multiple CSI reporting configurations etc., which will favor spatial domain network energy saving. On the other hand, the present disclosure contributes to the evolvements of wireless communication technologies, and can facilitate the implementation and application of NR.

Aspects of the present disclosure are described in the context of a wireless communications system.

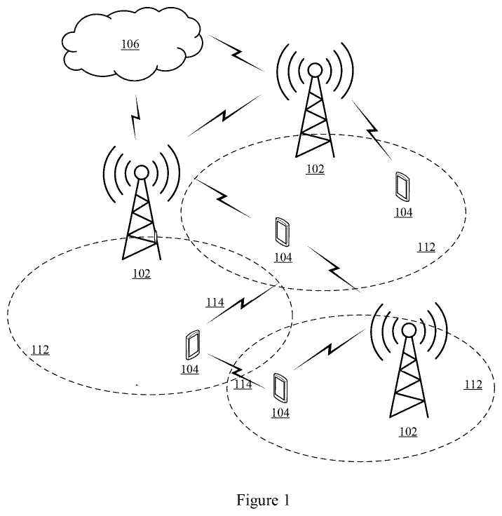

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple

### Access (cdma), Etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHZ), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A NE, e.g., a gNB may configure a CSI-RS resource set, e.g., a non-zero power (NZP) CSI-RS resource set for UE, e.g., by a radio resource control (RRC) signaling or another signaling, which includes one or more CSI-RS resources. CSI reporting can be based on the CSI-RS resource. The CSI reporting can be a CRI reporting or reporting at least one reporting configuration index or reporting sub-configuration index. UE will receive the CSI-RS resource set from the NE. Although RAN1 #113 has agreed using port subset indications to determine spatial domain adaptation for Type 1 case, and each CSI-RS resource is associated with a spatial domain adaptation pattern for Type2 case, there is no details regarding common or separate CRI reporting. How to determine association between port subset indication and spatial domain adaption pattern in Type 1 case and association between CSI-RS resource and spatial domain adaption pattern in Type 2 case need to be settled, so that a CSI-RS resource index for CRI reporting can be determined. Similarly, how to determine association between CMR and IMR to support interference measurement, and how to determine an index of a CSI reporting configuration or CSI reporting sub-configuration for CSI reporting etc., should also be solved in Type 1 and Type 2 cases.

In accordance with aspects of the present disclosure, in Type 1 case, NE will determine a set of port subset indications for the CSI-RS resource set. A port subset indication may also be referred to as a port subset configuration. NE will indicate one or multiple port subset indications associated with the CSI-RS resource set or associated with each CSI-RS resource of the CSI-RS resource set, e.g., by RRC signaling, MAC CE or DCI signaling. For example, NE will indicate one or more port subset indications for each CSI-RS resource of the CSI-RS resource set. In this case, the port subset indication is per CSI-RS resource. For another example, NE will indicate one or more port subset indication for all CSI-RS resources of the CSI-RS resource set. In this case, the port subset indication is per CSI-RS resource set. All CSI-RS resources in the CSI-RS resource set share the same port subset indications.

UE will determine the set of port subset indications for the CSI-RS resource set, e.g., based on port subset indications for each CSI-RS resource in the CSI-RS resource set. Each port subset indication of the set of port subset indications will be identified by an index. For example, the port subset indications for the CSI-RS resource set will be indexed sequentially. In some implementations of the present disclosure, port subset indications for each CSI-RS resource are the same. The set of port subset indications for the CSI-RS resource set is the one or multiple port subset indications for each CSI-RS resource. In some other implementations of the present disclosure, the port subset indications for each CSI-RS resource are different, the set of port subset indications for the CSI-RS resource set include port subset indications for all CSI-RS resources of the CSI-RS resource set. In this case, the port subset indications for the CSI-RS resource set are the union set of the port subset indications for each CSI-RS resource of the CSI-RS resource set.

In accordance with aspects of the present disclosure, in Type 2 case, NE will indicate a number (hereafter, the first number) by a signaling, e.g., a RRC signaling or another signaling, which is smaller than the number of CSI-RS resources in the CSI-RS resource set. For example, NE will indicate a beam number or spatial domain adaption pattern number, which can be used as the number for dividing CSI-RS resources of the CSI-RS resource set into one or more CSI-RS resource subsets. For example, there is a CSI-RS resource set with 6 CSI-RS resources, and the indicated number is 2, then there will be 3 subsets, wherein each subset contains 2 CSI-RS resources. Alternatively, there will be 2 subsets, and each subset contains 3 CSI-RS resources.

Regarding CRI reporting, in accordance with aspects of the present disclosure, in Type 1 case, each port subset indication is associated with a spatial domain adaptation pattern. For example, the first port subset indication in the set of port subset indications for the CSI-RS resource set is associated with the first spatial domain adaptation pattern, and the second port subset configuration is associated with the second spatial adaptation pattern.

Based on each port subset indication, CSI-RS resource subsets of the CSI-RS resource set will be determined, each CSI-RS resource subset containing at least one CSI-RS resource. CRI reporting for each CSI reporting configuration, or CSI reporting sub-configuration or port subset indication will be based on the determined CSI-RS resource subsets. For example, in some implementations of the present disclosure, UE will determine a CSI-RS resource subset for each port subset indication based on port subset indications for each CSI-RS resource of the CSI-RS resource set. UE will determine an index of a CSI-RS resource associated with a port subset indication based on a CSI-RS resource subset associated with the port subset indication, which will be used for CRI reporting.

For different CSI-RS resources in a CSI-RS resource subset, the different CSI-RS resources may correspond to different beams. Since the number of port subset indications for each CSI-RS are the same or different, the number of spatial domain adaptation patterns for each CSI-RS are the same or different. In the case that the number of spatial domain adaptation patterns for different CSI-RS resources are different, the number of spatial domain adaptation pattern or the number of port subset indications for the CSI-RS resource set is the largest number, e.g., N, of spatial domain adaptation patterns among those for all the CSI-RS resources in a CSI-RS resource set.

In the case that the number of port subset indications for each CSI-RS resource is different, the number of CSI-RS resource for each port subset indication may be also different. For example, for a first port subset indication, the associated CSI-RS resources are only partial of CSI-RS resources of the CSI-RS resource set, e.g. L. While for a second port subset indication, the associated CSI-RS resources contain all resources in the CSI-RS resource set, e.g. N. L is smaller than N. When determining the number of bits for CRI reporting, N will be used. In some implementations of the present disclosure, any (L-N) CSI-RS resources selected from the L CSI-RS resources will be appended to the corresponding CSI-RS resource (which may also be referred to as assumed CSI-RS resource or dummy CSI-RS resource), so that the number of CSI-RS resources is N. In other words, the number of CSI-RS resources corresponding to the spatial adaptation pattern will be N by appending (L-N) CSI-RS resources selected from L CSI-RS resources to the corresponding spatial domain adaption pattern. Regarding “assumed or dummy CSI-RS resource” or the like, it means that the CSI-RS resource are just assumed to be added to the existing L CSI-RS resource, which are not really used for the corresponding CRI reporting. In some implementations of the present disclosure, in the case that separate CRI reporting for different CSI reporting configurations corresponding to different spatial domain adaption patterns or different port subset indications is adopted, the indicated CRI is only associated with CSI-RS resource within the corresponding CSI-RS resources for a corresponding port subset indication.

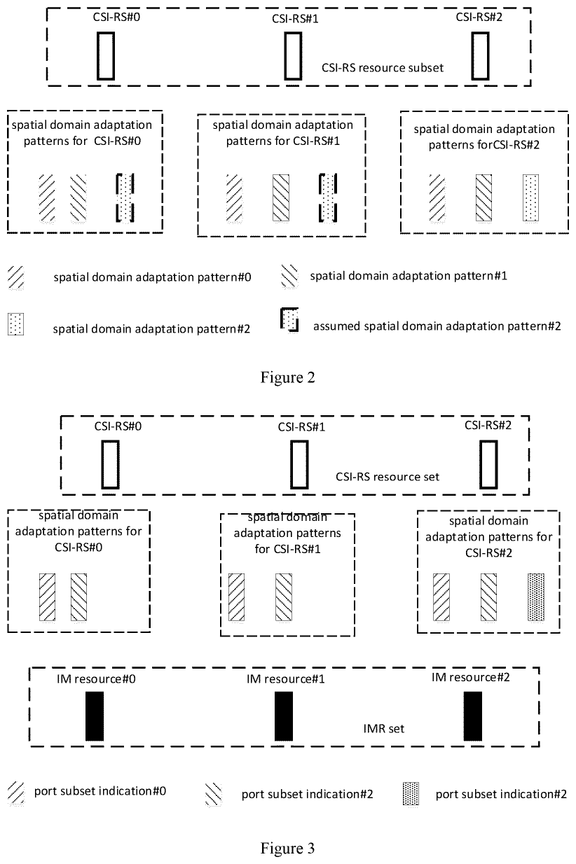

FIG. 2 is an example of association between spatial domain adaption patterns and CSI-RS resources in Type 1 case in accordance with aspect of the present disclosure.

Referring to FIG. 2, it is assumed that three port subset indications (not shown) are determined for a CSI-RS resource set configuration for UE, which are sequentially indexed and respectively indicates three spatial domain adaption patterns, e.g., spatial domain adaption pattern #0, spatial domain adaption pattern #1, and spatial domain adaption pattern #2. A subset of CSI-RS resources of the CSI-RS resource set includes three NZP CSI-RS resources, e.g., CSI-RS #0, CSI-RS #1 and CSI-RS #2. In addition, it is assumed that there are 2 port subset indications configured for each of CSI-RS #0 and CSI-RS #1, wherein, the two port subset indications indicate two spatial domain adaption pattern #0 and spatial domain adaption pattern #1 for each of CSI-RS #0 and CSI-RS #1. It is also assumed that there are 3 port subset indications configured for CSI-RS #2, wherein, the three port subset indications indicate the three spatial domain adaption patterns, e.g., spatial domain adaption pattern #0, spatial domain adaption pattern #1, and spatial domain adaption pattern #2 for CSI-RS #2. The largest number of spatial domain adaption patterns among those for each CSI-RS resource in the CSI-RS resource subset is 3. Thus, the spatial domain adaption pattern number for the CSI-RS resource subset is 3. Since there are only two real spatial domain adaption patterns for CSI-RS #0 and CSI-RS #1, one spatial domain adaption pattern, e.g., spatial domain adaption pattern #2 will be assumed to be appended to the spatial domain adaption patterns for each of CSI-RS #0 and CSI-RS #1. Any one of the three CSI-RS resources can be the CRI selected for spatial domain adaption pattern #0 and spatial domain adaption pattern #1, while only CSI-RS #2 can be the CRI selected for spatial domain adaption pattern #2 because it is not real corresponding to spatial domain adaption pattern #0 and spatial domain adaption pattern #1.

In accordance with aspects of the present disclosure, in Type 2 case, each CSI-RS resource is associated with a spatial domain adaptation pattern. Multiple CSI-RS resources may be associated with the same spatial domain adaptation pattern, and the multiple CSI-RS resources associated with the same spatial domain adaptation pattern may be associated with different beams.

To keep the configuration and reporting simple, in accordance with aspects of the present disclosure, the number of spatial domain patterns for each beam is the same, and meanwhile the number of beams for each spatial domain adaptation pattern is also the same. For example, the CSI-RS resources in the CSI-RS resource set are equalized divided into multiple CSI-RS subsets. In some implementations of the present disclosure, UE will determine multiple CSI-RS resource subsets by dividing the CSI-RS resource set by the first number, e.g., the number of beams, or the number of spatial domain adaptation patterns. NE will configure the number of beams, or the number of spatial domain adaptation pattern or both of them for the CSI-RS resource set for the UE. The number of beams for different spatial domain adaptation patterns may be same or different. The indicated largest beam number (may be the same same) among those for different spatial domain adaptation patterns will be deemed as the number of CSI-RS resources in each of the multiple CSI-RS resource subsets. The number of spatial domain adaptation patterns for different beams may also be same or different. The indicated largest spatial domain adaptation pattern number (may be the same) for different beams will be deemed as the number of the multiple CSI-RS resource subsets. In this manner, technical solutions applied in Type 2 case will be similar to those applied in Type 1 case, wherein port subset indications will be replaced by CSI-RS indexes in the corresponding CSI-RS resource subset.

For Type 2 case, the CRI reporting will be based on a CSI-RS subset associated with a spatial adaptation pattern. A CSI-RS resource within the CSI-RS subset or in the original CSI-RS resource set can be considered as the CRI.

In some implementations of the present disclosure (Scheme 1), CSI-RS resources in a CSI-RS resource subset are associated with the same CSI reporting configuration or CSI reporting sub-configuration. Each CSI-RS resource subset is associated with a spatial domain adaptation pattern. The number of beams for different spatial domain adaptation patterns are the same or different. In the case that the number of beams for different spatial domain adaptation patterns are different, the largest one among all the beam numbers for spatial domain adaptation patterns will be used for determining the CSI-RS resource subsets. Mapping among CSI-RS resources, beams and spatial domain adaption patterns is beam first, and spatial domain adaptation pattern second (also referred to as a mapping order of beam first). That is, CSI-RS resources will be first mapped to beams and then to spatial domain adaptation patterns. UE will select or determine a CSI-RS resource index to be reported from the CSI-RS resource subset. That is, UE will determine CRI based on an associated CSI-RS resource subset.

In some other implementations of the present disclosure (Scheme 2), the CSI-RS resources in a CSI-RS resource subset are associated with different CSI reporting configurations or CSI reporting sub-configurations. Each CSI-RS resource subset is associated with a beam. The number of spatial domain adaption patterns for different beams are the same or different. In the case that the number of spatial domain adaptation patterns for different beams are different, the largest one among all the spatial domain adaptation pattern numbers for beams will be used to determine the bit size for indication of spatial adaptation pattern. Mapping among CSI-RS resources, beams and spatial domain adaption patterns is spatial domain adaptation pattern first, and beam second ((also referred to as a mapping order of spatial domain adaption pattern first)). UE will determine multiple CSI-RS resource groups of the CSI-RS resource set based on the association between CSI-RS resource and CSI reporting configuration or sub-configuration, wherein CSI-RS resources in each of the multiple CSI-RS resource groups are associated with the same CSI reporting configuration or sub-configuration. UE will determine or select a CSI-RS resource group index to be reported from the multiple CSI-RS resource groups. That is, UE will determine the CSI reporting configuration index or CSI reporting sub-configuration index based on an associated CSI-RS resource group.

The mapping order, e.g., beam first or spatial domain adaptation pattern first will be configured for the UE by the NE, e.g., by a gNB or be predefined in the specification or protocol. Based on the mapping order, UE can determine whether Scheme 1 or Schem 2 will be adopted for CRI reporting in Type 2 case.

Regarding interference measurement (IM), resources for channel measurement and for interference measurement are resource-wise associated. For example, the first channel measurement resource and the first interference measurement resource are associated to determine the first CSI, or channel quality indicator (CQI), precoding matrix indicator (PMI), rank indicator (RI), etc.). RAN1 #113 has agreed support configurability of NZP CSI-RS resource(s) for channel measurement within one resource setting corresponding to more than one spatial adaptation patterns with at least one of A1-1-revised and A1-2-revised. In accordance with A1-1-revised, a resource set with multiple resources is configured within a resource setting, where each resource is associated with only one spatial adaptation pattern. In accordance with A1-2-revised, for a resource configured in a resource set within a resource setting, the resource can be associated with more than one spatial adaptation patterns. One or more resources can be configured in the resource set for channel measurement.

The network side, e.g., a gNB will indicate an IMR set for the UE, e.g., by a RRC signaling or another signaling. Herein, it is assumed that the CSI-RS resource set configured for the UE is used for channel measurement. That is, CSI-RS resources in the CSI-RS resource set are channel measurement resources.

In accordance with aspects of the present disclosure, in Type 1 case, different port subset indications associated with the same CSI-RS resource are used to represent different spatial domain adaptation patterns. Relationship or association between channel measurement resources and interference measurement resource will be updated based on legacy technology.

For example, in some implementations of the present disclosure, the number of CMRs are the same as the number of IMRs, which is the same as the number of CSI-RS resources in the CSI-RS resource set. Each port subset indication associated with the same CSI-RS resource are associated with the same IMR. Thus, one or multiple port subset indications are associated with the same IMR. UE will determine an IMR associated with a port subset indication based on a CSI-RS resource associated with the IMR.

In some other implementations of the present disclosure, the number of IMRs in the IMR set is determined based on the number of CSI-RS resources in CSI-RS resource set and the largest number (may be the same) of port subset indications among those of port subset indications for each CSI-RS resource in the CSI-RS resource set. For example, in the case of the same port subset indication number for each CSI-RS resource, the number of IMRs in the IMR set is a product of multiplication of the number of CSI-RS resources in CSI-RS resource set and the port subset indication number. In the case of different port subset indication numbers for different CSI-RS resources, the number of IMRs in the IMR set is a product of multiplication of the number of CSI-RS resources in CSI-RS resource set and the largest port subset indication number for all CSI-RS resources among the CSI-RS resource set. UE will determine an index of the IMR associated with a port subset indication based on the index of the associated port subset indication and an index of the associated CSI-RS resource. In addition, one to one mapping between port subset indication and IMR will be maintained.

FIG. 3 is an example of association among spatial domain adaption pattern, IMR and CMR in Type 1 case in accordance with aspect of the present disclosure.

Referring to FIG. 3, it is assumed that the number of CMRs are the same as the number of IMRs which is the same as the number of CSI-RS resources in the CSI-RS resource set. Port subset indications associated with each CSI-RS resource will also be associated with the corresponding IMR. For example, there are three CSI-RS resources in the CSI-RS set, e.g., CSI-RS #0, CSI-RS #1 and CSI-RS #2, and there are three IMRs in the IMR set, e.g., IMR #0 associated with CSI #0, IMR #1 associated with CSI #1 and IMR #2 associated with CSI #2. Port subset indications #0 of CSI-RS #0 will be associated with IMR #0. Port subset indications #1 of CSI-RS #0 will be associated with IMR #0. Port subset indications #0 of CSI-RS #1 will be associated with IMR #1.Port subset indications #1 associated with CSI-RS #1 will be associated with IMR #1. Port subset indication #2 of CSI-RS resource #2 will be associated with IMR #2. Different port subset indications associated with the same CSI-RS resource are used to represent different spatial domain adaptation patterns associated with the same CSI-RS resource.

In Type 2 case, mapping between beam, spatial domain adaptation pattern and CSI-RS resource will impact the association between channel measurement resource and interference measurement resource. In accordance with aspects of the present disclosure, the number of IMRs in the IMR set will equal to the number of CSI-RS resources in CSI-RS resource set, or the number of CSI-RS resource subsets determined by dividing the CSI-RS resource set by the first number in the case of the first number being the number of CSI-RS resources in each CSI-RS resources subset, or the number of CSI-RS resources in a CSI-RS resources subset in the case of the first number being the number of CSI-RS resource subsets. Similarly, the number of CSI-RS resources in a CSI-RS resource subset may correspond to the beam number, and the number of CSI-RS resource subsets may correspond to the spatial domain adaption pattern number. CSI-RS resources of a CSI-RS resource subset are associated with the same IMR. UE will determine an index for each CSI-RS resource of a CSI-RS resource subset to identify the CSI-RS resource within the CSI-RS resource subset based on an order of the CSI-RS resource within the CSI-RS resource subset. Then, UE will determine the IMR associated with each CSI-RS resource of the CSI-RS resource subset based on the determined index.

For example, the number of CSI-RS resources in the CSI-RS resource set is L, e.g., 6, the number of beams is M, e.g., 2, and the number of spatial adaptation patterns is N, e.g., 3, wherein L=M*N. Similarly, mapping order among CSI-RS resource, beam and spatial domain adaption pattern may be beam first or spatial domain adaptation pattern first.

In some implementations of the present disclosure, the number of IMRs is L. The number of CMRs is also L. CMRs and IMRs are resource-wise associated. The mapping order for CMRs and IMRs is the same, e.g., beam first or spatial domain adaption pattern first.

In some other implementations of the present disclosure, the number of IMRs is M. In the case of a mapping order of beam first, the IMR resource index, e.g., J for a CMR (e.g., a CSI-RS) with an index, e.g., K is determined as: J(K)=K mod N. In the case of a mapping order of spatial domain adaptation first, the IMR resource index J for a CMR with an index K is determined as: J(K)=K/N.

In some yet other implementations of the present disclosure, the number of IMRs is N. In the case of a mapping order of beam first, the IMR resource index, e.g., J for a CMR with an index, e.g., K is determined as: J(K)=K/M. In the case of a mapping order of spatial domain adaption pattern first, the IMR resource index, e.g., J for a CMR with an index, e.g., K is determined as: J(K)=K mod M.

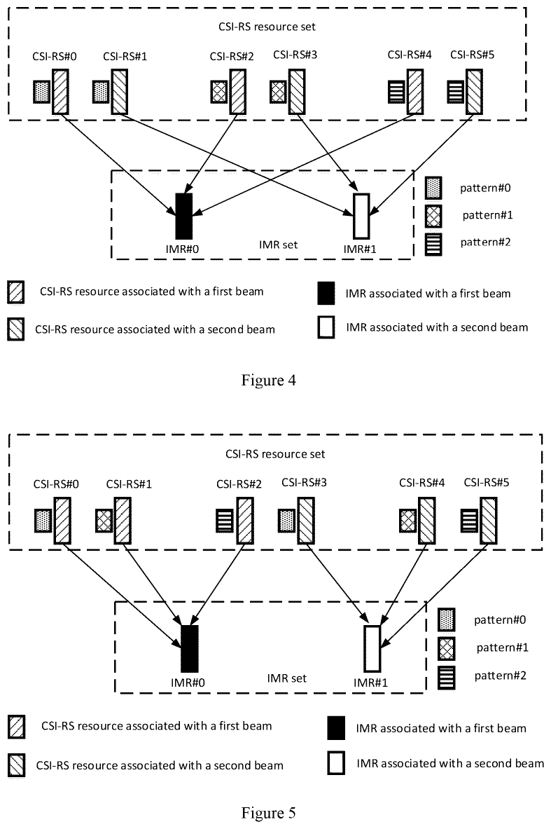

FIG. 4 is an example of association among spatial domain adaption pattern, IMR and CMR in Type 2 case in accordance with aspect of the present disclosure.

Referring to FIG. 4, it is assumed that there are 6 CMRs, e.g., 6 CSI-RS resources in the CSI-RS resource set, e.g., CSI-RS #0 to CSI-RS #5, two IMRs in the IMR set, e.g., IMR #0 and IMR #1, two beams and three spatial domain adaption patterns, e.g., pattern #0, pattern #1 and pattern #2. That is, the IMR number in the IMR set is the same as the beam number. It is also assumed that the mapping order is beam first. Then, the 6 CSI-RS resources will be mapped to the two beams first, e.g., CSI-RS #0 being mapped to the first beam, CSI-RS #1 being mapped to the second beam, CSI-RS #2 being mapped to the first beam, CSI-RS #3 being mapped to the second beam, CSI-RS #4 mapped to the first beam and CSI-RS #5 being mapped to the second beam. There are two CSI-RS resource subsets based on the two beams, each corresponding to an IMR. Then, the first one of each subset is mapped to the first spatial domain adaption pattern, e.g., pattern #0, the second one of each subset is mapped to the second spatial domain adaption pattern, e.g., pattern #1 and so on. Accordingly, CSI-RS #0 and CSI-RS #1 are mapped to pattern #0, CSI-RS #2 and CSI-RS #3 are mapped to pattern #1, and CSI-RS #4 and CSI-RS #5 are mapped to pattern #1. CSI-RS resource #0, CSI-RS #2 and CSI-RS #4 will be associated with IMR #0, and CSI-RS resource #1, CSI-RS #3 and CSI-RS #5 will be associated with IMR #1.

FIG. 5 is also an example of association among spatial domain adaption pattern, IMR and CMR in Type 2 case in accordance with aspect of the present disclosure.

Referring to FIG. 5, similarly, it is assumed that there are 6 CMRs, e.g., 6 CSI-RS resources in the CSI-RS resource set, e.g., CSI-RS #0 to CSI-RS #5, two IMRs in the IMR set, e.g., IMR #0 and IMR #1, two beams and three spatial domain adaption patterns, e.g., pattern #0, pattern #1 and pattern #2. That is, the IMR number in the IMR set is the same as the beam number. However, it is assumed that the mapping order is spatial domain adaption pattern first. Then, the 6 CSI-RS resources will be mapped to the three spatial domain adaption patterns first, e.g., CSI-RS #0 being mapped to pattern #0, CSI-RS #1 being mapped to pattern #1, CSI-RS #2 being mapped to pattern #2, CSI-RS #3 being mapped to pattern #0, CSI-RS #4 being mapped to pattern #1, and CSI-RS #5 being mapped to pattern #2. There are two CSI-RS resource subsets based on the two beams, each corresponding to an IMR. Then, the first subset including the first three CSI-RS resources mapped to the three spatial domain adaption patterns will be mapped to the first beam, and the second subset including the second three CSI-RS resources mapped to the three spatial domain adaption patterns will be mapped to the second beam. Accordingly, CSI-RS #0, CSI-RS #1 and CSI #2 are mapped to the first beam and correspond to IMR #0, and CSI-RS #3, CSI-RS #4 and CSI #5 are mapped to the second beam and correspond to IMR #1.

In addition, regarding CSI reporting, it has been agreed network side configured (or selected) UE reporting (e.g., gNB-configured UE reporting) for one or multiple CSI reporting configurations or sub-configurations. However, how to index the one or multiple CSI reporting configurations/sub-configurations and/or spatial domain adaptation patterns has not been agreed yet.

For example, in accordance with aspects of the present disclosure, the network side may indicate the number of CSI reporting configurations or CSI reporting sub-configurations to the UE, e.g., by a RRC signaling or another signaling. UE will transmit indexes of one or more CSI reporting configurations or CSI reporting sub-configurations based on the number. In Type 1 case, each index is associated with a port subset indication. In Type 2 case, based on whether the mapping order is beam first or spatial domain adaptation first as aforementioned in Scheme 1 and Scheme 2, the associated CSI-RS resource for each beam can be determined. For example, each CSI reporting configuration index is based on a subset index in the case of a mapping order of beam first or a group index in the case of a mapping order of spatial domain adaption pattern first.

In addition to gNB selected CSI reporting configurations to be reported, in accordance with aspects of the present disclosure, UE will select CSI reporting configurations or sub-configurations to be reported. NE, e.g., a gNB will configure UE to report metrics for a number, e.g., P of CSI reporting configurations or sub-configurations. The reporting metric can be CQI, PMI, RI or LI. UE will select the best P CSI reporting configurations or sub-configurations to report to the NE. For example, UE can judge whether a CSI reporting configuration is good or not based on RI or CQI. UE will report metrics for the selected P CSI reporting configurations or sub-configurations and indexes of the selected P CSI reporting configurations or sub-configurations.

Although the above implementations of the present disclosure are illustrated mainly in view of UE operations, persons skilled in the art would well know the consistent operations in the network side based on the UE operations, and thus similar or identical operations in the network side will not be repeated.

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for receiving a first signaling indicating a CSI-RS resource set; means for receiving a second signaling indicating one or multiple port subset indications associated with the CSI-RS resource set or indicating a first number smaller than a number of CSI-RS resources in the CSI-RS resource set; and means for determining, based on the first signaling and the second signaling, an index of a CSI-RS resource for CRI reporting, an association between CMR and IMR, an index of a CSI reporting configuration, or any combination thereof.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

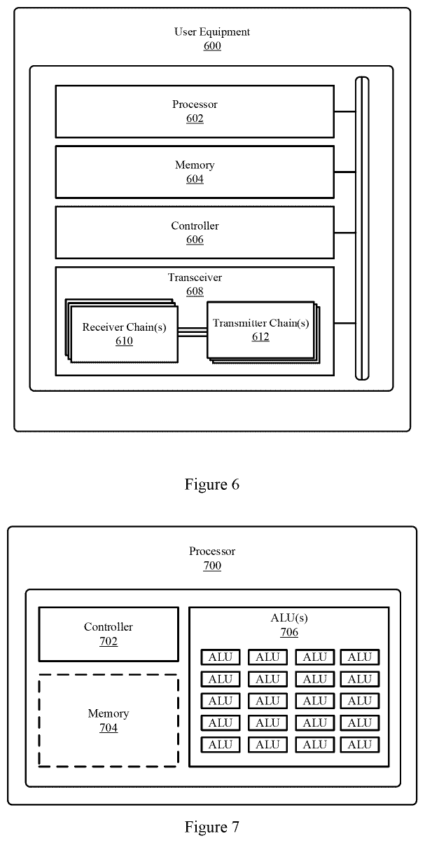

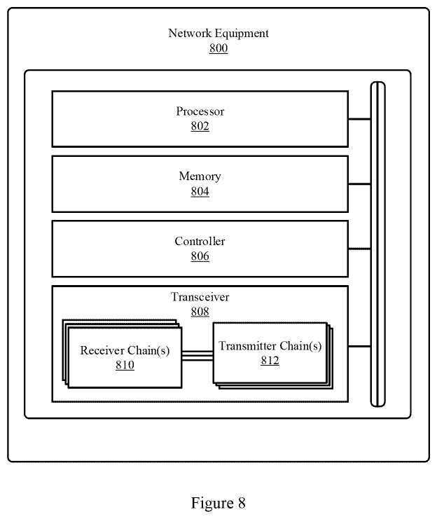

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means for receiving a first signaling indicating a CSI-RS resource set; means for receiving a second signaling indicating one or multiple port subset indications associated with the CSI-RS resource set or indicating a first number smaller than a number of CSI-RS resources in the CSI-RS resource set; and means for determining, based on the first signaling and the second signaling, an index of a CSI-RS resource for CRI reporting, an association between CMR and IMR, an index of a CSI reporting configuration, or any combination thereof.

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for receiving a first signaling indicating a CSI-RS resource set; means for receiving a second signaling indicating one or multiple port subset indications associated with the CSI-RS resource set or indicating a first number smaller than a number of CSI-RS resources in the CSI-RS resource set; and means for determining, based on the first signaling and the second signaling, an index of a CSI-RS resource for CRI reporting, an association between CMR and IMR, an index of a CSI reporting configuration, or any combination thereof.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

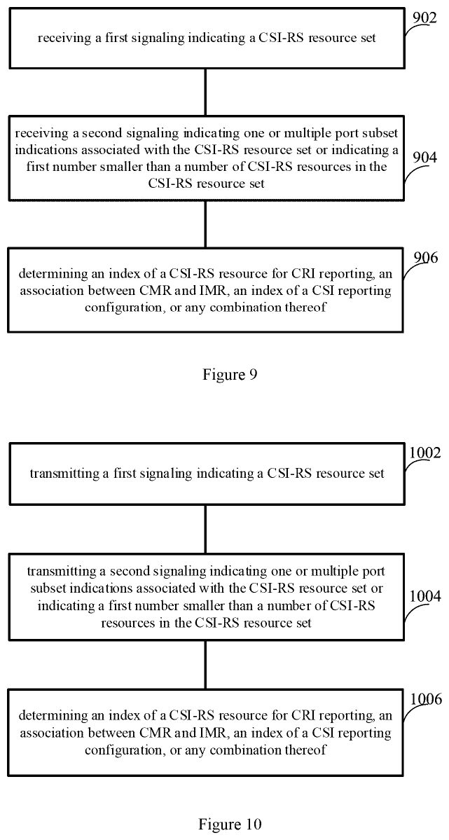

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include receiving a first signaling indicating a CSI-RS resource set. The operations of 902 may be performed in accordance with examples as described herein. In some implementations, aspects of the operations of 902 may be performed by a UE as described with reference to FIG. 6.

At 904, the method may include receiving a second signaling indicating one or multiple port subset indications associated with the CSI-RS resource set or indicating a first number smaller than a number of CSI-RS resources in the CSI-RS resource set. The operations of 904 may be performed in accordance with examples as described herein. In some implementations, aspects of the operations of 904 may be performed by a UE as described with reference to FIG. 6.

At 906, the method may include determining, based on the first signaling and the second signaling, an index of a CSI-RS resource for CRI reporting, an association between CMR and IMR, an index of a CSI reporting configuration, or any combination thereof. The operations of 906 may be performed in accordance with examples as described herein. In some implementations, aspects of the operations of 906 may be performed a UE as described with reference to FIG. 6.

It should be noted that the method described herein describes a possible implementation, and that the operations and the steps may be rearranged or otherwise modified and that other implementations are possible.

FIG. 10 illustrates a flowchart of a method in accordance with aspects of the present disclosure. The operations of the method may be implemented by a NE as described herein. In some implementations, the NE may execute a set of instructions to control the function elements of the NE to perform the described functions.

At 1002, the method may include transmitting a first signaling indicating a CSI-RS resource set. The operations of 1002 may be performed in accordance with examples as described herein. In some implementations, aspects of the operations of 1002 may be performed by a NE as described with reference to FIG. 8.

At 1004, the method may include transmitting a second signaling indicating one or multiple port subset indications associated with the CSI-RS resource set or indicating a first number smaller than a number of CSI-RS resources in the CSI-RS resource set. The operations of 1004 may be performed in accordance with examples as described herein. In some implementations, aspects of the operations of 1004 may be performed by a NE as described with reference to FIG. 8.

At 1006, the method may include determining, an index of a CRI reporting, an association between CMR and IMR, an index of a CSI reporting configuration, or any combination thereof, based on the CSI-RS resource set and the one or multiple port subset indications or the first number. The operations of 1006 may be performed in accordance with examples as described herein. In some implementations, aspects of the operations of 1006 may be performed a NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive a first signaling indicating a channel state information (CSI) reference signal (RS) (CSI-RS) resource set;
receive a second signaling indicating one or multiple port subset indications associated with the CSI-RS resource set or indicating a first number smaller than a number of CSI-RS resources in the CSI-RS resource set; and
determine, based on the first signaling and the second signaling, an index of a CSI-RS resource for CSI-RS resource indicator (CRI) reporting, an association between a channel measurement resource (CMR) and an interference measurement resource (IMR), an index of a CSI reporting configuration, or any combination thereof.

2. The UE of claim 1, wherein the at least one processor is configured to cause the UE to: determine a set of port subset indications for the CSI-RS resource set based on port subset indications for each CSI-RS resource in the CSI-RS resource set, wherein each port subset indication of the set of port subset indications is identified by an index.

3. The UE of claim 1, wherein the at least one processor is configured to cause the UE to:
determine a CSI-RS resource subset of the CSI-RS resource set for each port subset indication based on port subset indications for each CSI-RS resource of the CSI-RS resource set; and
determine an index of a CSI-RS resource associated with a port subset indication based on a CSI-RS resource subset associated with the port subset indication to be reported.

4. The UE of claim 1, wherein the at least one processor is configured to cause the UE to: determine one or multiple CSI-RS resource subsets by dividing the CSI-RS resource set by the first number, wherein a number of CSI-RS resources in each of the one or multiple CSI-RS resource subsets equals to the first number, or a number of the one or multiple CSI-RS resource subsets equals to the first number.

5. The UE of claim 4, wherein CSI-RS resources in a CSI-RS resource subset are associated with a same CSI reporting configuration or different CSI reporting configurations.

6. The UE of claim 5, wherein, when the CSI-RS resources in a CSI-RS resource subset are associated with the same CSI reporting configuration, the at least one processor is configured to cause the UE to determine an index of a CSI-RS resource in the CSI-RS resource subset to be reported.

7. The UE of claim 6, wherein, when the CSI-RS resources in a CSI-RS resource subset are associated with different CSI reporting configurations, the at least one processor is configured to cause the UE to determine multiple CSI-RS resource groups of the CSI-RS resource set based on an association between CSI-RS resource and CSI reporting configuration, and wherein CSI-RS resources in each of the multiple CSI-RS resource groups are associated with a same CSI reporting configuration.

8. The UE of claim 1, wherein the at least one processor is configured to cause the UE to receive a third signaling indicating an IMR set, and wherein the CSI-RS resource set indicated by the first signaling is for channel measurement.

9. The UE of claim 8, wherein a number of IMRs in the IMR set is the same as the number of CSI-RS resources in the CSI-RS resource set, and wherein the one or multiple port subset indications are associated with a same IMR.

10. The UE of claim 9, wherein the at least one processor is configured to cause the UE to determine an IMR associated with a port subset indication based on a CSI-RS resource associated with the IMR.

11. The UE of claim 8, wherein a number of IMRs in the IMR set is determined based on the number of CSI-RS resources in the CSI-RS resource set and a largest number of port subset indications among those of port subset indications for each CSI-RS resource in the CSI-RS resource set.

12. The UE of claim 11, wherein numbers of port subset indications for different CSI-RS resources in the CSI-RS resource set are same or different.

13. The UE of claim 11, wherein the at least one processor is configured to cause the UE to determine an index of the IMR associated with a port subset indication based on an index of the associated CSI-RS resource and an index of the associated port subset indication.

14. The UE of claim 8, wherein a number of IMRs in the IMR set equals to the number of CSI-RS resources in the CSI-RS resource set.

15. The UE of claim 14, wherein the at least one processor is configured to cause the UE to:
determine an index for each CSI-RS resources of a CSI-RS resource subset to identify the CSI-RS resource within the CSI-RS resource subset based on an order of the CSI-RS resource within the CSI-RS resource subset; and
determine the IMR associated with each CSI-RS resource of the CSI-RS resource subset based on the index.

16. The UE of claim 5, wherein the at least one processor is configured to cause the UE to:
receive a third signaling indicating a number of CSI reporting configurations; and
transmit indexes of one or more CSI reporting configurations based on the number of CSI reporting configurations, wherein each CSI reporting configuration index is based on a subset index.

17. The UE of claim 7, wherein the at least one processor is configured to cause the UE to:
receive a third signaling indicating a number of CSI reporting configurations; and
transmit indexes of one or more CSI reporting configurations based on the number of CSI reporting configurations, wherein each CSI reporting configuration index is based on a group index.

18. A processor for wireless communication, comprising:
at least one controller coupled with at least one memory and configured to cause the at least one processor to:
receive a first signaling indicating a channel state information (CSI) reference signal (RS) (CSI-RS) resource set;
receive a second signaling indicating one or multiple port subset indications associated with the CSI-RS resource set or indicating a first number smaller than a number of CSI-RS resources in the CSI-RS resource set; and
determine, based on the first signaling and the second signaling, an index of a CSI-RS resource for CSI-RS resource indicator (CRI) reporting, an association between a channel measurement resource (CMR) and an interference measurement resource (IMR), an index of a CSI reporting configuration, or any combination thereof.

19. A network equipment (NE) for wireless communication, comprising:
at least one memory; and
at least one processor coupled with the at least one memory and configured to cause the RAN node to:
transmit a first signaling indicating a channel state information (CSI) reference signal (RS) (CSI-RS) resource set;
transmit a second signaling indicating one or multiple port subset indications associated with the CSI-RS resource set or indicating a first number smaller than a number of CSI-RS resources in the CSI-RS resource set; and
determine an index of a CSI-RS resource for CSI-RS resource indicator (CRI) reporting, an association between a channel measurement resource (CMR) and an interference measurement resource (IMR), an index of a CSI reporting configuration, or any combination thereof, based on the CSI-RS resource set and the one or multiple port subset indications or the first number.

20. A method performed by a user equipment (UE), the method comprising:
receiving a first signaling indicating a channel state information (CSI) reference signal (RS) (CSI-RS) resource set;
receiving a second signaling indicating one or multiple port subset indications associated with the CSI-RS resource set or indicating a first number smaller than a number of CSI-RS resources in the CSI-RS resource set; and
determining, based on the first signaling and the second signaling, an index of a CSI-RS resource for CSI-RS resource indicator (CRI) reporting, an association between a channel measurement resource (CMR) and an interference measurement resource (IMR), an index of a CSI reporting configuration, or any combination thereof.
